(19) United States
(12) Patent Application Publication
(10) Pub. No.: US 2010/0235460 A1
(43) Pub. Date: Sep. 16, 2010

(54) DATA PROCESSING DEVICE AND DATA PROCESSING METHOD

(75) Inventors: YOSHINORI MOCHIZUKI, Sagamihara (JP); HARUMI MORINO, Yokohama (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/697,259

(22) Filed: Jan. 31, 2010

(30) Foreign Application Priority Data
Mar. 13, 2009 (JP) 2009-060968

(51) Int. Cl. G06F 15/16

(52) U.S. Cl. 709/208

(57) ABSTRACT

A network host is dynamically changed so that a processing burden on each device comprising a network does not become excessive. Data processing devices are equipped with a short-distance radio communication circuit that carries out short-distance radio communication by periodically outputting beacon information for making the relevant device recognized by others and receiving externally supplied beacon information. When a radio communication network is comprised of these data processing devices, each short-distance radio communication circuit is provided with a function of, when the relevant device participates in the short-distance radio communication network, dynamically changing the network host according to the result of recognition of externally supplied beacon information. As a result, the following is implemented even for a system for radio communication networks in which attention is originally not focused on a network host function like UWB: information communication required for changing a network host is carried out using a beacon information recognition function essentially provided therein. Therefore, it is possible to suppress increase in a processing burden on each device comprising the network.

### CLAIM OF PRIORITY

The Present application claims priority from Japanese application JP 2009-060968 filed on Mar. 13, 2009, the content of which is hereby incorporated by reference into this application.

### FIELD OF THE INVENTION

The present invention relates to data processing devices and data processing methods and in particular to a data processing device comprising a short-distance radio communication network and a data processing method for managing a network slave function and a network host function assigned to the data processing device.

### BACKGROUND OF THE INVENTION

In recent years, radio communication that does not need cables has been increasingly used on various scenes. Especially, UWB (Ultra Wide Band) that utilizes a wide band of several GHz width and enables high-speed communication at several hundreds of Mbps (Mega Bit Per Second) has recently begun to attract attention. As a specification for UWB, there is ECMA-368 (abbreviation of European Computer Manufacturer Association-368). In ECMA-368, the physical layer and the MAC (Media Access Control address) layer are defined and it is possible to implement various applications calling for high-speed radio communication on a common platform.

Patent Document 1 describes a network system in which a host device can be dynamically selected and a device of the highest suitability is selected according to priorities determined based on property information indicating the properties of the devices in the network. The document describes that the following technique can be adopted at this time: an ordinary device carries out one-to-many communication (broadcasting or multicasting) to multiple devices and responses to the one-to-may communication are received from the devices; and information for host device communication (for example, the network address of a host device) is extracted from the received responses to the one-to-may communication.

[Patent Document 1] Japanese Unexamined Patent Publication No. 2006-235989

### SUMMARY OF THE INVENTION

The specification laid down in ECMA-368 does not define the concept of coordinator that manages devices present in a network, defined in ZigBee (registered trademark), one of the standards for short-distance radio communication like UWB. That is, no device that manages a network exists among devices utilizing UWB.

In general, a lot of devices utilized in networks based on short-distance radio communication like UWB are application specific devices such as digital cameras and monitors, not high-performance devices such as PCs (Personal Computers). Incase of application specific devices, it is difficult to incorporate a security function because of price and performance. If there is a device not equipped with a security function in a network, however, there is a fear that another device present in the identical network will be attacked using the device as a stepping stone.

In consideration of the above circumstances, a host function for managing at least addition, deletion, and the like of devices comprising the network may be necessary. At this time, it is possible to review the function levels of surrounding devices to select the optimum device as the host as described in Patent Document 1. However, the present inventors found that to apply this to a system in which attention is originally not focused on a network host function like UWB, it is required to consider a new measure for implementing the following: a processing burden on each device comprising the network is prevented from becoming excessive.

It is an object of the invention to provide a data processing device and a data processing method wherein a network host function and a network slave function can be dynamically switched so that a processing burden on each device comprising a network will not become excessive.

The above and other objects and novel features of the invention will be apparent from the description in this specification and the accompanying drawings.

The following is a brief description of the gist of the representative elements of the invention laid open in this application:

A radio communication network is comprised of data processing devices including a short-distance radio communication circuit that carries out short-distance radio communication by periodically outputting beacon information for making itself recognized by others and receiving externally supplied beacon information. At this time, a function of, when a device participates in the short-distance radio communication network, dynamically changing a network host according to the result of recognition of externally supplied beacon information is adopted in the short-distance radio communication circuit. Thus, even for a system for a radio communication network in which attention is originally not focused on a network host function like UWB, information communication required for changing a network host is carried out using a beacon information recognition function essentially provided therein. Therefore, it is possible to suppress increase in a processing burden on each device comprising the network as much as possible and dynamically switch between a network host function and a network slave function. Especially, this switching processing is carried out when a data processing device is about to participate in the network. In other words, the switching processing is carried out when it becomes possible to transmit and receive beacon information for the first time in a network in which a device is about to participate. Therefore, it is unnecessary for the present network host to especially define or control the timing with which the operation for this purpose is started and this simplifies control for dynamically changing a network host.

The following is a brief description of the gist of an effect obtained by the representative elements of the invention laid open in this application:

It is possible to dynamically switch between a network host function and a network slave function so that a processing burden on each device comprising a network will not become excessive.

These and other features, objects and advantages of the present invention will become more apparent from the following description when taken in conjunction with the accompanying drawings.

### BRIEF DESCRIPTION OF THE DRAWINGS

FIG. 1 is a block diagram illustrating the schematical configuration of a home network as an example of a data processing network to which an embodiment of the invention is applied;

FIG. 2 is a block diagram illustrating as an example a host processing device as a data processing device in which a network host function is established;

FIG. 3 is an explanatory drawing illustrating the composition of a device management table as an example;

FIG. 4 is an explanatory drawing illustrating the composition of a network management table as an example;

FIG. 5 is a block diagram illustrating as an example a slave processing device managed and monitored by a host processing device;

FIG. 6 is an explanatory drawing illustrating the composition of a coupled device table as an example;

FIG. 7 is a flowchart illustrating as an example the sequence of initial operation of a processing device added to a network as the result of the turning-on of the power thereto;

FIG. 8 is a flowchart illustrating the operation sequence of host device change processing (Step 460) as an example;

FIG. 9 is a flowchart illustrating an interface control sequence in a host processing device as an example;

FIG. 10 is a flowchart illustrating the details of device information acquisition processing (Step 630) as an example;

FIG. 11 is a flowchart illustrating the details of device confirmation processing (Step 650) as an example;

FIG. 12 is a flowchart illustrating the details of time limit resetting processing (Step 670) as an example;

FIG. 13 is a flowchart illustrating as an example a procedure for dynamically changing a host processing device 200 when the power to the host processing device is turned off or when the host processing device is moved and gets out of the network;

FIG. 14 is a flowchart illustrating the operation sequence of host recognition processing by a slave processing device as an example;

FIG. 15 is a block diagram illustrating as an example a host processing device obtained by adding a wireless interface and a wireless control circuit to the host processing device illustrated in FIG. 2; and

FIG. 16 is a flowchart illustrating as an example device information acquisition processing by a processing device equipped with a wireless interface.

### DETAILED DESCRIPTION OF THE PREFERRED EMBODIMENTS

### 1. Summary of the Preferred Embodiments

Description will be given to the outline of typical embodiments of the invention disclosed in this application. The reference numerals in drawings referred to with parentheses in the following description of the outline of the typical embodiments just exemplify what contained in the concept of constituent elements marked with the reference numerals.

(1) A data processing device in a typical embodiment of the invention is coupled to a radio communication network as a host device or a slave device. (When caused to function as a network host, the data processing device is data processing device 200 and when caused to function as a network slave, the data processing device is data processing device 300.) The data processing device includes: a radio communication circuit (210) that transmits beacon information for making any other data processing device recognize the data processing device as the relevant device and receives beacon information transmitted from any other data processing device; and a control circuit (220, 230) that carries out control to cause the data processing device as the relevant device to participate as a host device or a slave device in the radio communication network. This control is carried out according to whether or not beacon information transmitted from the other data processing device has been received.

As a result, the following is implemented even for a radio communication network system in which attention is originally not focused on a network host function like UWB: information communication required for changing a network host is carried out using a beacon information recognition function essentially provided therein. Therefore, it is possible to suppress increase in a processing burden on each device comprising the network as much as possible and dynamically switch between a network host function and a network slave function. Especially, this switching processing is carried out when a data processing device is about to participate in the network. In other words, the switching processing is carried out when it becomes possible to transmit and receive beacon information for the first time in the network in which the device is about to participate. Therefore, it is unnecessary to the present network host to especially define or control the timing with which the operation for this purpose is started and this simplifies control for dynamically changing a network host.

(2) As a concrete embodiment of the data processing device in Section 1 above, the control circuit carries out the following control: control to cause the data processing device as the relevant device to participate as a host device or a slave device in the radio communication network. This control is carried out according to whether or not beacon information transmitted from the other data processing device has been received and whether or not a host request command transmitted from the other data processing device has been received.

(3) <At Participation in Network>

As a further concrete embodiment of the data processing device in Section 1 above, the control circuit carries out the following processing: (a) When the radio communication circuit does not receive beacon information transmitted from the other data processing device, it causes the data processing device as the relevant device to participate as a host device in the radio communication network (400, 410); (b) When the radio communication circuit receives the beacon information transmitted from the other data processing device and a host request command from the other data processing device, it causes the data processing device as the relevant device to participate as a host device in the radio communication network (440, 460); and (c) When the radio communication circuit receives the beacon information transmitted from the other data processing device and does not receive a host request command from the other data processing device, it causes the data processing device as the relevant device to participate as a slave device in the radio communication network (440, 450, 470).

According to this, it is possible to suppress increase in a processing burden on each device comprising the network and dynamically switch between a network host function and a network slave function as mentioned above. Further, it is possible to significantly simplify control for dynamically changing a network host.

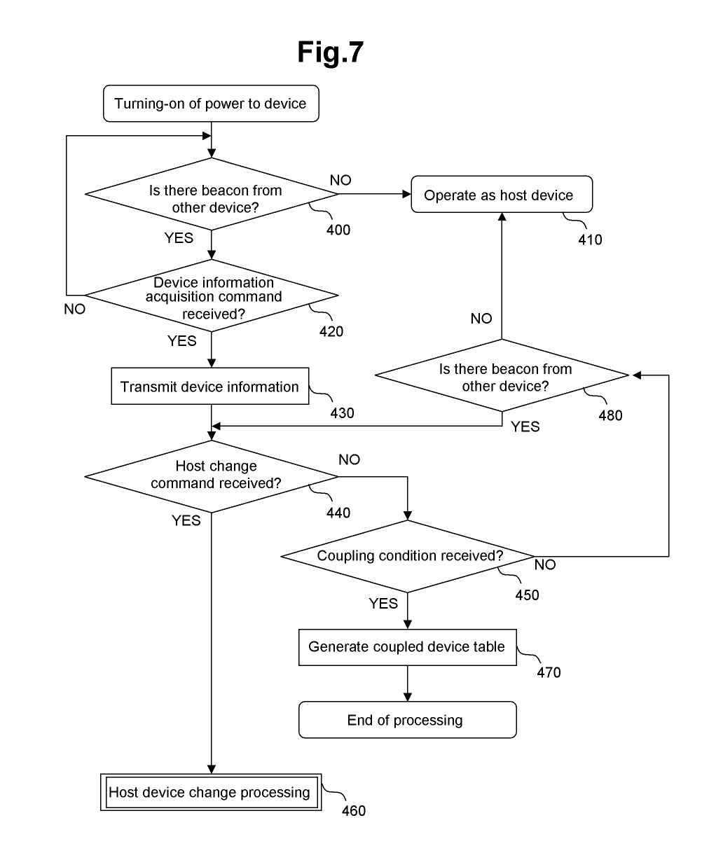

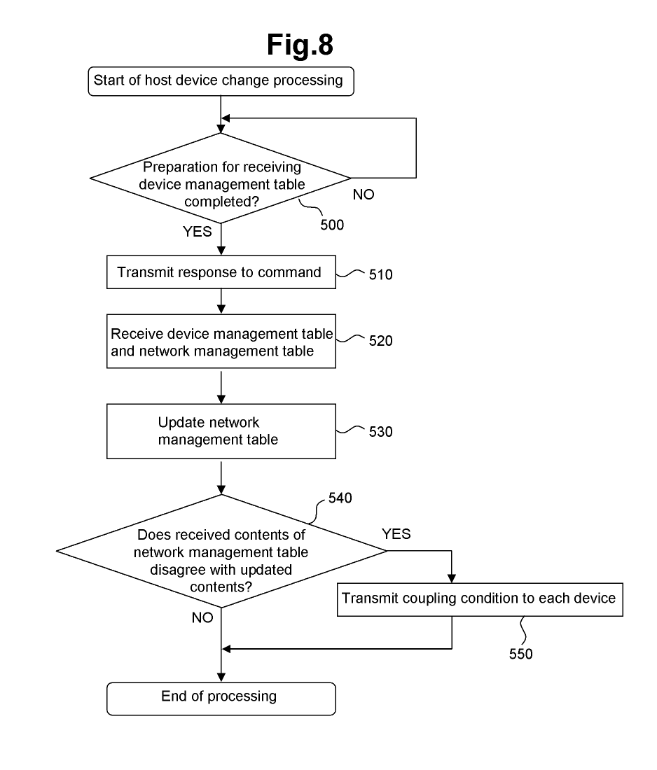

(4) In the data processing device in Section 3 above, the control circuit carries out the following processing when the host request command is received and it causes the data processing device as the relevant device to participate as a host device in the radio communication network: it updates management tables (250, 260) for the present host device sent back by transmitting a response to the host request command; and it generates its own management tables for the host device in a memory circuit (FIG. 7, FIG. 8). According to this, tables for host management to be referred to by a data processing program or a logic circuit for performing a network host function are updated. As a result, even a data processing device newly participating in the network can easily perform a network host function.

(5) In the data processing device in Section 4 above, the management tables for the host device include the following information with respect to each address assigned to data processing devices: the attribute information of each data processing device and the address information of any other data processing device that can be coupled. As a result, the network host can perform the following operations: it can exclude a data processing device not entered in management tables for the host from the communication targets; and it can prevent communication to a communication target other than those permitted in the management tables for the host. This contributes to the enhancement of the security of the network.

(6) In the data processing device in Section 4 above, the control circuit carries out the following processing when the host request command is not received and it causes the data processing device as the relevant device to participate as a slave device in the radio communication network: based on a coupling condition supplied from the host device, it generates management tables for the slave device (350, 360) in the memory circuit (FIG. 7). Thus tables for the slave device to be referred to by a data processing program or a logic circuit for performing a network slave function are updated. As a result, even a data processing device newly participating in the network can easily perform a network slave function.

(7) In the data processing device in Section 6 above, the management tables for the slave device contain the address information of any other data processing device with which it is permitted to be coupled. As a result, a network slave itself can recognize a target with which it can communicate.

(8) <Network Host Function>

In the data processing device in Section 4 above, the control circuit carries out the following processing when it has caused the relevant device to participate as a host device in the network: when it transmits the host request command, it outputs management tables for the host device in response to a response from the destination of transmission; and further, it updates the management tables for the present host device in the memory circuit to its own management tables for the slave device and causes the relevant device to participate as a slave device in the network (630, 460A). Thus when a data processing device newly participating in the network becomes a network host, the present network host can easily become a network slave.

(9) <At Power-Off Operation>

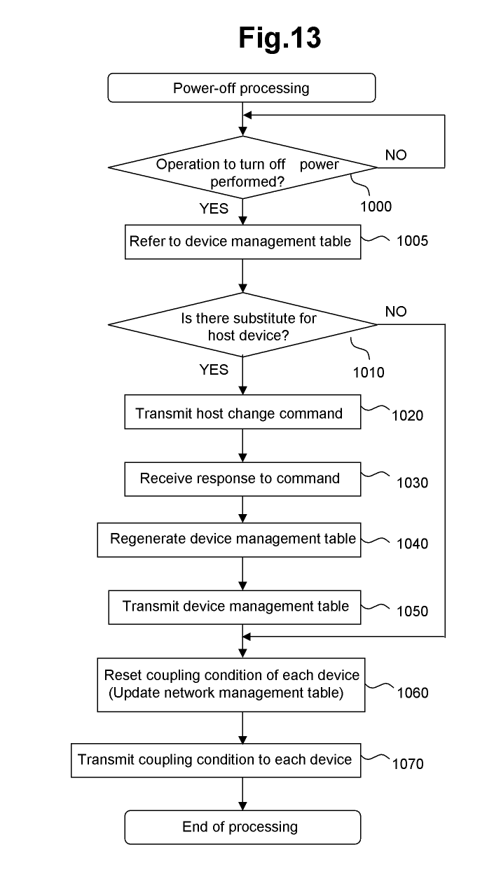

In the data processing device in Section 8 above, the control circuit performs the following processing when it has caused the relevant device to participate as a host device in the network: when an operation is performed to turn off operating power supply and there is a slave device that can take over a host function, it transmits a host request command; and it transmits management tables for the host to a slave device that responds thereto (FIG. 13). This makes it possible to systematically avoid the absence of a network host when power supply is turned off and a network host gets out of the network.

(10) <Host Device Declaration>

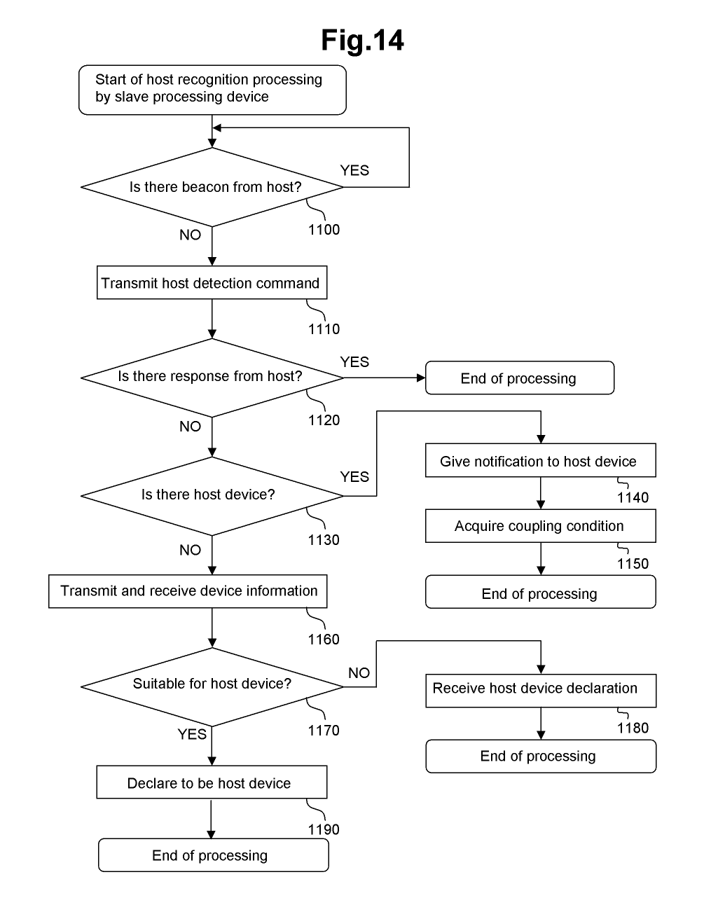

In the data processing device in Section 1 above, the control circuit carries out the following processing when it has caused the relevant device to participate as a slave device in the network: when it cannot receive beacon information from a host device, it issues a host detection command to the data processing devices at all the addresses; when the presence of a host device cannot be recognized even by all the responses thereto, it acquires the attribute information of the data processing devices at all the addresses; and when it is determined to be necessary based on the acquired attribute information, it declares to become the host device itself to the data processing devices at all the addresses (FIG. 14). As a result, a network slave can autonomously eliminate the absence of a network host.

(11) The data processing method according to another aspect of the invention includes first processing and second processing. In the first processing, beacon information for making any other data processing device recognize the data processing device as the relevant device coupled as a host device or a slave device to a radio communication network is transmitted; and beacon information transmitted from any other data processing device is received. In the second processing, control is carried out to cause the data processing device as the relevant device to participate as a host device or a slave device in the radio communication network. This control is carried out according to whether or not beacon information transmitted from the other data processing device has been received.

(12) As a concrete embodiment of the data processing method in Section 11 above, the second processing is processing in which control is carried out to cause the data processing device as the relevant device as a host device or a slave device in the radio communication network. This control is carried out according to whether or not beacon information transmitted from the other data processing device has been received and whether or not a host request command transmitted from the other data processing device has been received.

(13) <At Participation in Network>

As a further concrete embodiment of the data processing method in Section 11 above, the second processing is processing in which control is carried out so that the following is implemented: (a) When the radio communication circuit does not receive beacon information transmitted from the other data processing device, the data processing device as the relevant device is caused to participate as a host device in the radio communication network; (b) When the radio communication circuit receives the beacon information transmitted from the other data processing device and a host request command from the other data processing device, the data processing device as the relevant device is caused to participate as a host device in the radio communication network; and (c) When the radio communication circuit receives the beacon information transmitted from the other data processing device and does not receive a host request command from the other data processing device, the data processing device as the relevant device is caused to participate as a slave device in the radio communication network.

(14) In the data processing method in Section 11 above, the processing in which when the host request command is received in the second processing, the data processing device as the relevant device is caused to participate as a host device in the radio communication network includes the following processing: processing in which management tables for the present host device sent back by transmitting a response to the host request command are updated to generate its own management tables for the host device in the memory circuit.

(15) In the data processing method in Section 14 above, the management tables for the host device contain the following information with respect to each address assigned to data processing devices: the attribute information of each device and the address information of any other data processing device that can be coupled.

(16) In the data processing method in Section 11 above, the processing in which when the host request command is not received in the second processing, the data processing device as the relevant device is caused to participate as a slave device in the radio communication network includes the following processing: processing in which based on a coupling condition supplied from the host device, its own management tables for the slave device are generated in the memory circuit.

(17) In the data processing method in Section 14 above, the management tables for the slave device contain the address information of any other data processing device with which the relevant device is permitted to be coupled.

### 2. Further Detailed Description of the Preferred Embodiments

Further detailed description will be given to embodiments of the invention.

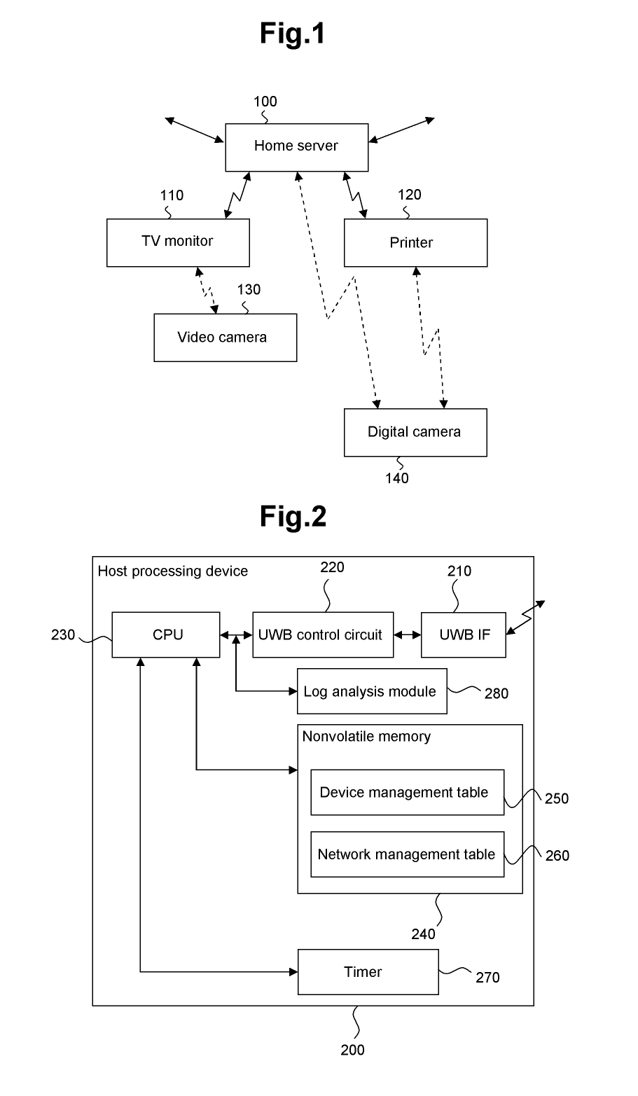

FIG. 1 illustrates the schematical configuration of a home network as an example of a data processing network to which an embodiment of the invention is applied.

When devices are equipped with a short-distance wireless interface such as UWB or Bluetooth, the devices can directly communicate with each other not by way of a router or a hub. In such a home network as illustrated in FIG. 1, a printer 120 and a digital camera 140 need not communicate with each other through a common network based on a home server 100. They can carry out radio communication directly with each other. Thus a photo stored in the digital camera 140 can be directly printed with the printer 120 without use of PC or external recording media. Similarly, an image picked up with a video camera 13 can be directly displayed on a TV monitor 110 by making sure that the TV monitor 110 and the video camera carry out radio communication directly with each other.

The devices indicated by reference numerals 100 to 140 are equipped with a data processing device that carries out short-distance radio communication. Each data processing device is caused to function as a network host (host device) or caused to function as a network slave (slave device). Some data processing devices are dedicated to a network slave function and a network slave function or a network host function can be selectively established in others.

In general, a lot of devices utilized in networks based on a short-distance wireless interface are application specific devices such as the printer 120 and the digital camera 140, not general-purpose devices, such as PCs. In case of application specific devices, it is difficult to incorporate a security function because of price and performance. If there is a device not equipped with a security function in a network, however, there is a fear that another device present in the identical network will be attacked using the device as a stepping stone.

To cope with this, in the example in FIG. 1, a network host function is established in one of the data processing devices. The data processing device with a network host function established therein will be designated as host processing device for the sake of convenience. A data processing device with a network slave function established therein will be designated as slave processing device for the sake of convenience. The host processing device has a function of managing and monitoring the devices present in the network. In FIG. 1, the bidirectional arrows of broken line denote communication through a short-distance wireless interface; and the bidirectional arrows of solid line denote communication through an interface other than the short-distance wireless interface though not especially limited to that. When designated as host processing device or slave processing device in this specification, it refers to a data processing device (processing device) for comprising a communication network based on a short-distance wireless interface. In FIG. 1, the host processing device is not limited to the data processing device provided in the home server 100. In this example, each data processing device includes a short-distance wireless interface circuit. This interface circuit carries out short-distance radio communication by periodically outputting beacon information for making the relevant device recognized by others and receiving the beacon information externally supplied. At least some of the data processing devices carry out processing that makes it possible to dynamically change a network host, triggered by the reception of beacon information, when they participate in a network. A short-distance radio network is comprised of data processing devices equipped with a short-distance wireless interface circuit. One of the devices is taken as a host processing device that performs a network host function and the others are taken as slave processing devices that perform a network slave function. Hereafter, description will be given a configuration and processing wherein a network host function can be dynamically switched when triggered by the reception of beacon information.

FIG. 2 is a block diagram illustrating as an example the configuration of a host processing device as a data processing device in which a network host function is established. The host processing device 200 includes a UWB interface circuit (UWBIF) 210 as a short-distance wireless interface circuit for communicating with a processing device present in the network. It is configured as, for example, a general-purpose microcomputer in the form of multi-chip or single-chip device. The short-distance wireless interface circuit need not be of UWB and may be based on such a short-distance radio communication method as Bluetooth.

In addition to the UWBIF 210, the host processing device 200 is equipped with the following circuits: a UWB control circuit 220, CPU (Central Processing Unit) 230, a nonvolatile memory 240, a timer 270, a log analysis module 280, and RAM, ROM, an interrupt controller, and the like which are not shown in the drawing.

The UWB control circuit 220 implements data communication in conformity with the ECMA-368 standard through the UWB interface circuit 210.

The timer 270 is used to measure the valid duration of each slave processing device present in the short-distance radio network managed and monitored by the host processing device 200.

The nonvolatile memory 240 is a memory such as EEPROM or flash memory. In the nonvolatile memory 240, there are stored a device management table 250 and a network management table 260 used by the host processing device 200 to manage and monitor the devices present in the network.

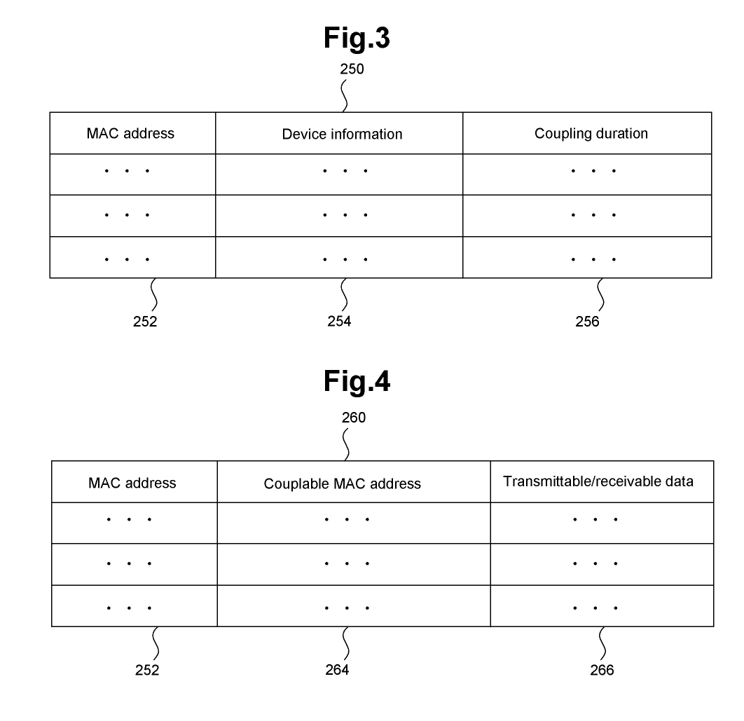

As illustrated in FIG. 3 as an example, each information entry in the device management table 250 contains MAC address 252, device information 254, and coupling duration 256.

The MAC address 252 is an address that uniquely identifies each device. The method for acquiring the MAC address 252 differs depending on the interface used. In case of UWB interface, beacon information periodically broadcast by each processing device equipped with a UWB interface contains a MAC address. The beacon information is information for making the presence of the relevant device known to others. In case of UWB interface, the beacon information contains, in addition to the MAC address of the source of transmission, the MAC address of each processing device with which the processing device that transmitted the beacon information can be coupled. For this reason, the following can be acquired by acquiring beacon information transmitted by a processing device: the MAC address of the processing device that transmitted the beacon information as well as the MAC address of each nearby processing device.

In the following description, a case where the beacon information of an UWB interface is utilized will be taken as an example. In case of a short-distance wireless interface without the mechanism of beacon like UWB interfaces, the following measure is taken: a command periodically broadcast to indicate the presence of the relevant device like a beacon is added; and the MAC address of each nearby processing device is acquired from beacon information sent as the result thereof.

The device information 254 includes: information pertaining to the type, such as monitor and digital camera, of each processing device; information pertaining to the type, such as freeze-frame picture and motion picture, of transmitted and received data; and information pertaining to the performance of each device, including communication speed, the amount of memory installed, the CPU spec, and the like.

The coupling duration 256 is a duration during which data can be transmitted and received in the network managed and monitored by the host processing device 200. The timer 270 is utilized to monitor this duration.

As illustrated in FIG. 4 as an example, the network management table 260 is comprised of MAC address 252, couplable MAC address 264, and transmittable/receivable data 266. When the amount of the nonvolatile memory 240 installed in the host processing device 200 is small, it may be so configured that the network management table 260 is not stored.

The couplable MAC address 264 indicates the MAC address of a processing device that can carry out data communication with the processing device indicated by the MAC address 252.

The transmittable/receivable data 266 indicates the type of data which the processing device indicated by the MAC address 252 can transmit to the couplable MAC address 264. An example of the type of this data is JPEG compressed data.

The log analysis module 280 monitors that each processing device present in the managed and monitored network is normally operating. Specifically, it analyzes a communication log held in each processing device. Aside from the analyses of communication logs, the following measure may be taken: packets flowing on the network are acquired utilizing the network management table 260; and it is confirmed that the correspondence between the address of the source of transmission and the type of data and the correspondence between the address of the destination of transmission and the type of data are matched with each other. The functions of the log analysis module 280 can also be described in software so that they are performed by the CPU. The processing devices may be so configured that the log analysis module 280 is not equipped depending on the performance of the host processing device 200.

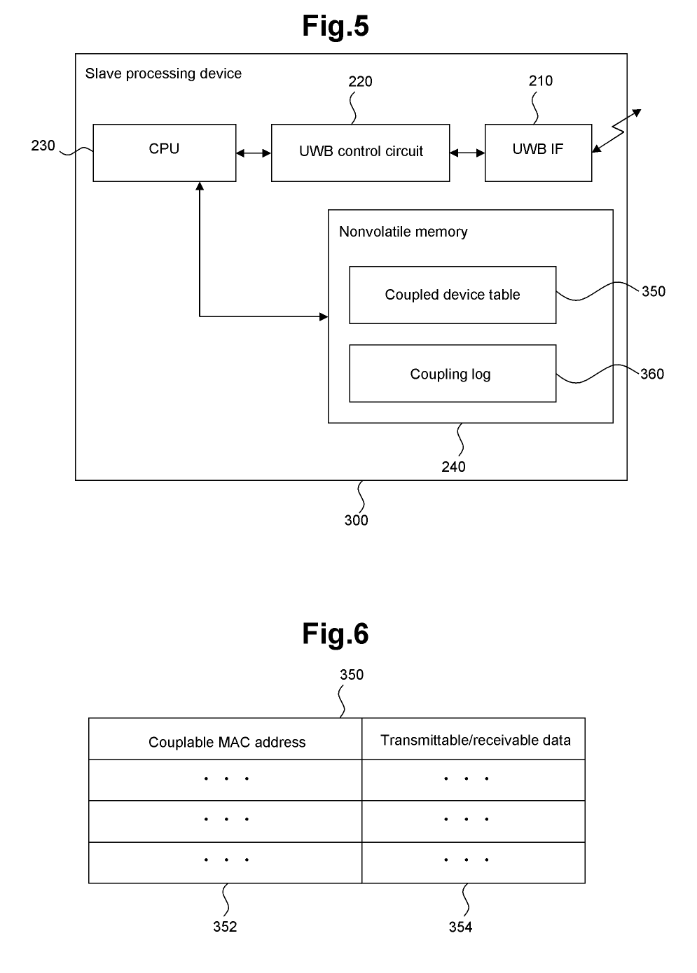

FIG. 5 illustrates as an example the internal configuration of a slave processing device managed and monitored by the host processing device 200. The configuration illustrated in FIG. 5 applies both to the slave processing device as a data processing device in which a network slave function is established and to a slave processing device in which a network slave function is fixed.

Similarly with the host processing device 200, the slave processing device 300 includes CPU 230, a UWB control circuit 220, and a nonvolatile memory 240.

In the nonvolatile memory 240, there are stored a coupled device table 350 and a coupling log 360. As illustrated in FIG. 6 as an example, the coupled device table 350 is comprised of the same elements as the network management table 260 held in the host processing device 200. That is, it is comprised of couplable MAC address 352 and transmittable/receivable data 354. Unlike the network management table 260, however, MAC addresses are not stored because only information pertaining to the slave processing device 300 itself has to be stored. Its own MAC address is held in the UWB control circuit 220 or the nonvolatile memory 240.

The coupling log 360 is a file in which the histories of data transmitted or received by the slave processing device 300 is stored. There are cases where all the histories cannot be stored and only histories for a certain period can be stored because of the amount of the nonvolatile memory 240 installed in the slave processing device 300. In such cases, it is required to provide a mechanism or the like for carrying out the following processing: the host processing device 200 requests the contents of the coupling log 360 at certain intervals and deletes them when there is no problem.

This embodiment is characterized in that a host processing device that manages and monitors the processing devices present in a network is dynamically changed according to the configuration of each of the processing devices present in the network. For this reason, a mechanism for carrying out the following processing is required: since some processing device is added to the network, a processing device that has been operating as a host processing device is switched to a slave processing device. Hereafter, description will be given to this mechanism for switching. A host processing device and a slave processing device are dynamically switched as mentioned above. Therefore, even a slave processing device may be equipped with the timer 270, the log analysis module 280, and the like. That is, the processing device that can be both a slave and a host is provided with a configuration required for it to function as a network host and a configuration required for it to function as a network slave. In this example, the network host function and the network slave function are defined by the operating program of the CPU 230. When the processing device uses the network host function, the CPU 230 executes a processing program for this purpose; and when it uses the network slave function, the CPU 230 executes a processing program for this purpose.

FIG. 7 illustrates the initial operation sequence of a processing device added to a network as the result of the power thereto being turned on. Also when a processing device is moved and added to the network, the same sequence is taken.

The processing device the power to which is turned on (Turning-on of power to device) does not transmit beacon information. Instead, it scans a communication path for a certain period to confirm that any other processing device is transmitting beacon information (Step 400).

When after this scanning, a processing device that is transmitting beacon information cannot be found, it can be determined that no processing device other than the relevant processing device is present on the network. Therefore, the processing device operates as the host processing device 200 (Step 410).

When after the above scanning, a processing device that is transmitting beacon information can be found, the relevant processing device waits for the host processing device 200 to transmit a device information acquisition command (Step 420). The device information acquisition command is a command transmitted to a processing device newly added to the network by the host processing device 200. A processing device that received this command must transmit the type and performance of itself to the host processing device 200. The host processing device 200 can grasp the type and performance of the added processing device through this command.

When the device information acquisition command is not transmitted from the host processing device 200, the flow returns to the processing of confirming that any other processing device is transmitting beacon information (Step 400).

When the device information acquisition command is transmitted from the host processing device 200, the processing device carries out the following processing: it transmits the device information, such as type and performance, of the processing device to the host processing device 200 in response to the command (Step 430).

After transmitting the device information, the processing device waits for the host processing device 200 to transmit a host change command or a coupling condition as a host request command (a command requested by the host device) (Step 440, Step 450). The host change command is a command transmitted to a processing device only in the following case: a case where the host processing device 200 determines that the processing device newly added to the network is more suitable for host processing device in terms of performance and functionality from device information transmitted by the processing device.

The coupling condition is information containing a couplable MAC address 352 and transmittable/receivable data 354 required for generating a coupled device table 350 required for the relevant processing device to operate as a slave processing device.

When the processing device receives the host change command, the host device change processing described in detail later is carried out (Step 460).

When the processing device does not receive the host change command but a coupling condition, it generates a coupled device table 350 according to the received coupling condition (Step 470).

When the relevant processing device receives beacon information at Step 400 but does not receive a host change command or a coupling condition, it confirms that any other processing device is transmitting beacon information (Step 480).

When it can be confirmed that any other processing device is transmitting beacon information, the relevant processing device waits for the host processing device 200 to transmit a host change command or a coupling condition. To request the host processing device 200 to transmit a host change command or a coupling condition, the processing device may broadcast a request command.

When beacon information is not transmitted from any other processing device, it can be determined that no processing device other than the relevant processing device is present on the network. Therefore, the relevant processing device operates as the host processing device 200.

FIG. 8 is a flowchart illustrating the operation sequence of the host device change processing (Step 460) by the processing device.

When the processing device transmits a response to the host change command to the host processing device 200, the host processing device 200 transmits the contents of the device management table 250 and the network management table 260. Therefore, the relevant processing device confirms that it is ready to receive data from the host processing device 200 (Step 500).

When the relevant processing device is ready to receive data, it transmits a response to the host change command to the host processing device 200 (Step 510). When the relevant processing device has not been ready for reception, it may periodically transmit a response during preparation to notify the host processing device 200 that it is getting ready.

Subsequently, the relevant processing device receives the contents of the device management table 250 and the network management table 260 transmitted by the host processing device 200 that received the response to the host change command (Step 520). After receiving the contents of the device management table 250 and the network management table 260, the relevant processing device updates the contents of the network management table 260 (Step 530). When as the result of this updating, the contents of the network management table becomes different from the contents transmitted by the host processing device 200, the relevant processing device transmits this result to each processing device (Step 540, Step 550).

When the host processing device 200 transmits only the device management table 250 because of the nonvolatile memory 240, it is required for the processing device to generate a network management table 260. After generating the network management table 260, it is required to transmit the result of this generation to all the processing devices.

Above is the description of the initial operation sequence of a processing device newly added to a network and the operation sequence for a processing device to start its operation as a host processing device.

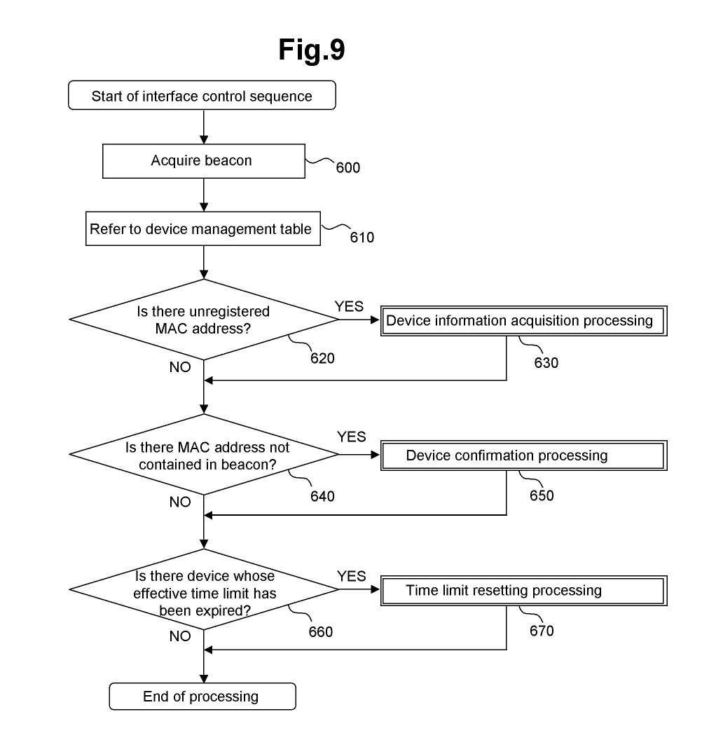

FIG. 9 illustrates the interface control sequence of the host processing device 200 as an example.

Each time the host processing device 200 receives beacon information transmitted by each slave processing device 300, it refers to the device management table 250 and checks the items of MAC address 252 and coupling duration 256 (Step 600, Step 610).

When after the device management table 250 is referred to, there is an unregistered MAC address, device information acquisition processing is carried out (Step 620, Step 630). The device information acquisition processing will be described in detail later.

The MAC addresses contained in beacon information transmitted by the individual slave processing devices 300 are all registered in the device management table 250. When a MAC address not contained in beacon information transmitted by each slave processing device 300 has been registered in the device management table 250, device confirmation processing is carried out (Step 640, Step 650). The device confirmation processing will be described in detail later.

When there is no problem with respect of MAC address but there is a slave processing device 300 the effective time limit of the coupling duration of which has been expired, time limit resetting processing (Step 660, Step 670). The time limit resetting processing will be described in detail later. Each processing may be configured as dedicated hardware and this hardware may be installed in the host processing device 200 to carry out the processing to shorten processing time. Alternatively, only some processing may be configured as dedicated hardware and this hardware may be installed in the host processing device 200 to carry out the processing. Hereafter, detailed description will be given to each processing (Step 630, Step 650, Step 670).

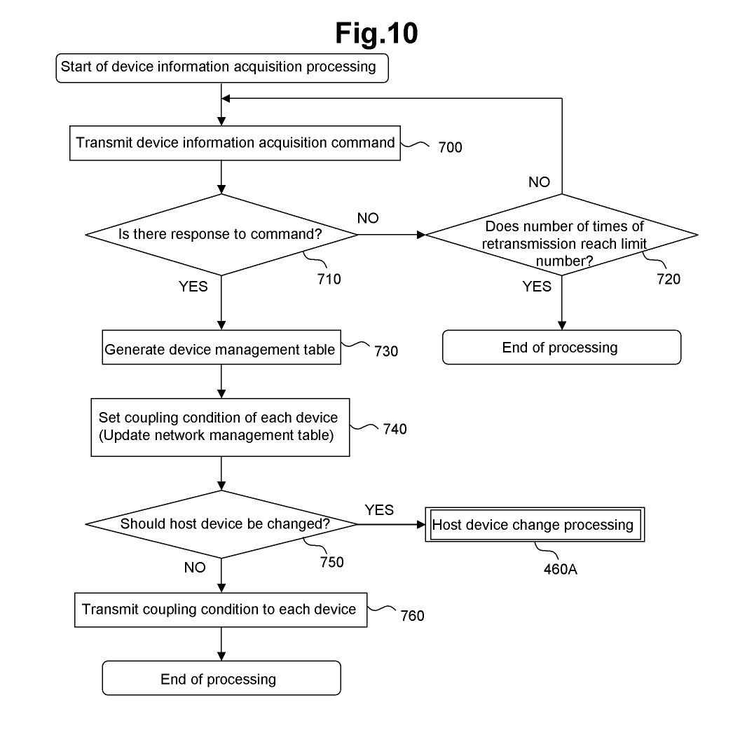

FIG. 10 illustrates the details of the device information acquisition processing (Step 630). The corresponding operation on the processing device side is the processing of Step 420 to Step 470 in FIG. 7.

When there is a MAC address that has not been registered in the device management table 250, the host processing device 200 carries out the following processing: it transmits a device information acquisition command to the processing device indicated by that MAC address and waits for a response to the command (Step 700, Step 710).

When there is no response to the device information acquisition command, the command is transmitted again. When the number of times of retransmission reaches a certain limit number, the device information acquisition processing is terminated (Step 720). Even when beacon information transmitted by the processing device indicated by the MAC address cannot be confirmed, the device information acquisition processing may be terminated.

When there is a response to the device information acquisition command, a device management table 250 is generated utilizing information required to generate the device management table, contained in the response (Step 730). Subsequently, the coupling condition of each slave processing device to the relevant processing device is set and the network management table 260 is updated (Step 740). After the device management table 250 and the network management table 260 are generated and updated, and when the relevant processing device is more suitable for host processing device in terms of performance and functionality, host device change processing is carried out (Step 750, Step 460A). When the relevant processing device is not suitable for host processing device, the contents of the network management table 260 are transmitted to each slave processing device (Step 760). This completes the sequence of device information acquisition processing. The host device change processing at Step 460A is processing on the present host processing device, corresponding to the host device change processing in FIG. 8. In this processing, the host change command is transmitted, the device management table is transmitted, and the network management table is transmitted; and then a coupled device table is generated based on the present device management table and network management table to change the present host processing device to a slave processing device.

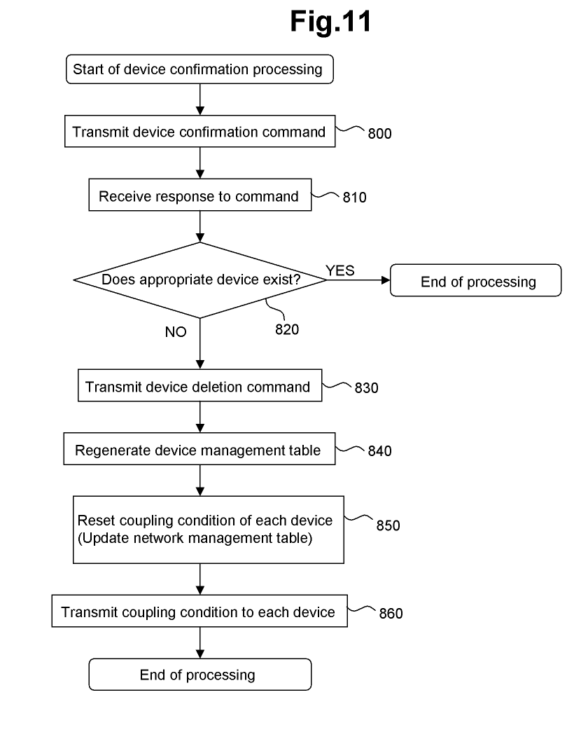

FIG. 11 illustrates an example of the procedure for the device confirmation processing (Step 650) in detail. When a MAC address not contained in beacon information transmitted by each slave processing device is contained in the device management table 250, the host processing device 200 carries out the following processing: it transmits a device confirmation command to all the slave processing devices present in the network it manages and monitors, for confirming that the appropriate processing device exists (Step 800).

When as the result of reception of each slave processing device's response to the device confirmation command, the presence of the appropriate processing device can be confirmed, the device confirmation processing is terminated (Step 810, Step 820).

When the presence of the appropriate processing device cannot be confirmed, the host processing device transmits a device deletion command to all the slave processing devices present in the network it manages and monitors (Step 830). The device deletion command is a command to delete information pertaining to the appropriate processing device from the coupled device table 350. In addition, the device management table 250 and the network management table 260 held in the host processing device 200 are regenerated and reset (Step 840, Step 850). As the result of the regeneration and resetting, the host processing device 200 transmits a coupling condition to each slave processing device (Step 860). This completes the device confirmation processing (Step 650).

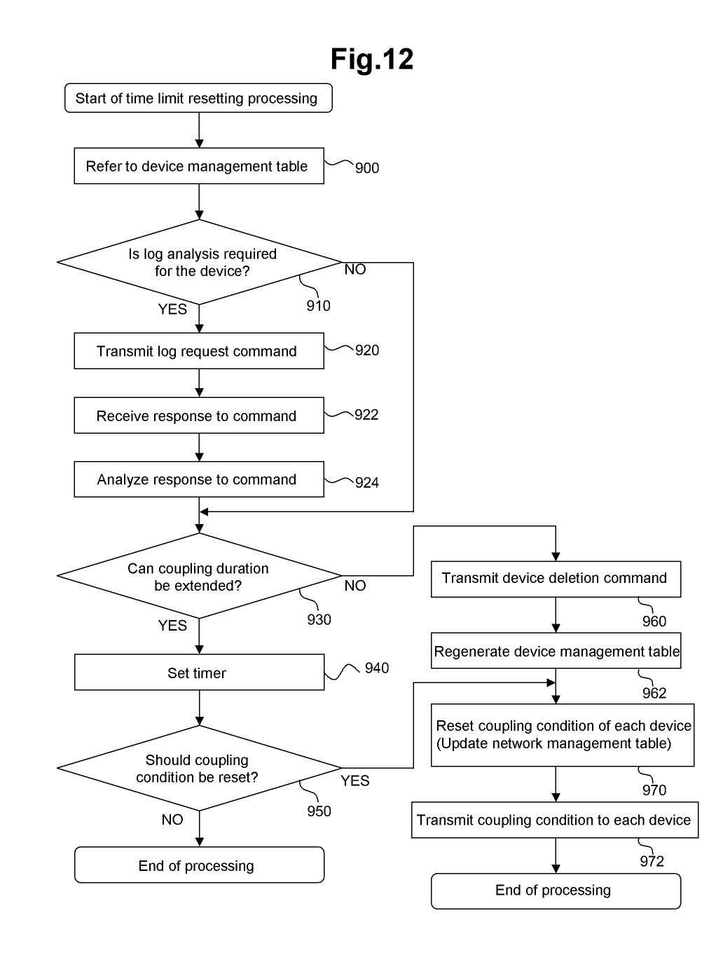

FIG. 12 illustrates an example of the time limit resetting processing (Step 670) in detail. When there is a slave processing device the effective time limit of the coupling duration 256 of which has been expired, the host processing device 200 carries out the following processing: it refers to the device management table 250 and confirms that the slave processing device whose effective time limit has been expired is a processing device for which a log analysis is required (Step 900, Step 910).

When the slave processing device is one for which a log analysis is required, the host processing device 200 transmits a log request command to that slave processing device (Step 920). The log request command is a command requesting to transmit the coupling log 360 stored in the nonvolatile memory installed in a slave processing device to the host processing device 200.

The slave processing device that received the log request command transmits the coupling log 360 stored in its nonvolatile memory 240 to the host processing device 200 in response to the command (Step 922). When the coupling log 360 is not stored because of the nonvolatile memory installed in the slave processing device, a reply to that effect is transmitted to the host processing device 200 in response to the command.

The host processing device 200 analyzes the received coupling log 360 and confirms that the slave processing device is a processing device whose coupling duration can be extended (Step 924, Step 930). When it is determined at Step 910 that the slave processing device is a processing device whose coupling log 360 need not be analyzed, the processing of Step 920 to Step 924 is skipped.

When the slave processing device is a processing device whose coupling duration can be extended, the host processing device 200 resets the timer 270 and updates the device management table 250 (Step 940).

Further, when it is required to modify the coupling condition of each of the other slave processing devices to the appropriate slave processing device, the host processing device 200 carries out the following processing: it resets the coupling condition to the appropriate slave processing device and transmits the reset coupling condition to each slave processing device (Step 970, Step 972). When the host processing device 200 holds the network management table 260, it also updates the network management table 260.

When the slave processing device is a processing device whose coupling duration cannot be extended, the host processing device 200 carries out the following processing: it transmits a device deletion command to each slave processing device to request to delete information pertaining to the slave processing device from the coupled device table 350 held in each slave processing device; and it regenerates the device management table 250 (Step 960, Step 962).

Further, when it is required to modify the coupling condition of each of the other slave processing devices to the appropriate slave processing device, the host processing device 200 carries out the following processing: it resets the coupling condition to the appropriate slave processing device and transmits the reset coupling condition to each slave processing device (Step 970, Step 972). When the host processing device 200 holds the network management table 260, it also updates the network management table 260. This completes the time limit resetting processing (Step 670).

The following can be implemented by carrying out the above processing: the host processing device 200 that manages the processing devices present in a network can be dynamically changed utilizing beacon information periodically transmitted by each processing device.

The above processing is applied to a processing device newly added to a network. When the power to the host processing device 200 is turned off, a processing device that manages the network becomes absent. Consequently, description will be given to the processing of dynamically changing a host processing device 200 when the power to the host processing device 200 is turned off or when the host processing device 200 is moved and gets out of the network.

FIG. 13 illustrates an example of the procedure for dynamically changing a host processing device 200 when the power to the host processing device 200 is turned off or when the host processing device 200 is moved and gets out of the network.

When its power switch is operated and turned off (Step 1000), the host processing device 200 refers to the device management table 250 (Step 1005). Then it confirms that there is a slave processing device that can substitute for the host processing device (Step 1010). Examples of the confirming methods include: a method in which utilizing the device management table 250 stored in the nonvolatile memory 240, the host processing device 200 determines one having the functions of host processing device among the present slave processing devices; and a method in which a flag indicating whether or not it can operate as a host processing device is set beforehand on each processing device and this flag is notified to the host processing device 200 in response to the device information acquisition command.

When there is no slave processing device that can substitute for the host processing device, the coupling condition of each slave processing device is reset and this condition is transmitted to the slave processing device. Thereafter, the power to the host processing device is turned off (Step 1060, Step 1070).

If there is no host processing device 200 that manages the network, the host device change processing (Step 460) cannot be carried out anymore. Therefore, when the power to the present host device is turned off, it is required to cause some slave processing device to carry out the host device change processing (Step 460).

When there is a slave processing device that can substitute for the host processing device, the host processing device 200 transmits a host change command to that slave processing device (Step 1020).

The host processing device 200 waits for the slave processing device to transmit a response to the host change command (Step 1030). When there is no response to the host change command, the command is retransmitted to the slave processing device. Alternatively, when there is another slave processing device that can substitute for the host processing device, the command is transmitted to that slave processing device.

After receiving a response to the command, the host processing device 200 regenerates the device management table 250 and transmits the contents of the regenerated device management table 250 to the corresponding slave processing device (Step 1040, Step 1050).

After transmitting the contents of the device management table 250, the host processing device resets the coupling condition of each slave processing device and transmits this condition to the slave processing device. Thereafter, the power to the host processing device is turned off (Step 1060, Step 1070).

When there is no slave processing device that can substitute for the host processing device, the host processing device 200 carries out the following processing: it resets the coupling condition of each slave processing device to a condition for the absence of a host processing device and transmits the condition to the slave processing device. Thereafter, the power to the host processing device is turned off (Step 1010, Step 1060, Step 1070).

Above is the description of the operation sequence taken when the power to the host processing device 200 is turned off. However, though the above sequence is effective in cases where it is known beforehand that the power to the host processing device 200 will be turned off, it is difficult to cope with abrupt power-off by the above sequence.

FIG. 14 illustrates an example of the procedure for host recognition processing by a slave processing device. This procedure makes it possible to cope with abrupt interruption of power supply to the host processing device 200 by causing a slave processing device to recognize incapability of communication with the host processing device 200.

A slave processing device 300 confirms that the host processing device 200 is periodically transmitting beacon information (Step 1100). When beacon information is periodically transmitted, it can be determined that the host processing device 200 is managing and monitoring the network.

If the host processing device 200 is not transmitting beacon information, the slave processing device transmits a host detection command to all the other processing devices (Step 1110). The host detection command is a command to detect the host processing device 200. When the host processing device 200 receives this command, it replies that it still remains in the network in response. When among the slave processing devices, there is a slave processing device that has confirmed that the host processing device 200 is periodically transmitting beacon information, that slave processing device broadcasts that the host processing device is present in response.

When the host processing device 200 transmits a response to the host detection command, it can be determined that the host processing device 200 is managing and monitoring the network (Step 1120).

When a slave processing device transmits a response to the host detection command, there is the host processing device 200 on the network; however, it is unknown whether or not it can manage and monitor the relevant slave processing device 300. Therefore, the host processing device 200 is notified that the relevant slave processing device 300 still remains on the network through the slave processing device that transmitted the response (Step 1130, Step 1140).

As the result of this notification, the slave processing device receives a coupling condition in response and operates according to this coupling condition (Step 1150). The host processing device 200 updates the network management table 260 only when it modified a coupling condition and transmits the result of this updating to each slave processing device.

When there is no response to the host detection command, it can be determined that there is no host processing device 200 in the network. For this reason, it is required to find a new host processing device. First, each slave processing device broadcasts its own device information and receives the device information of the other slave processing devices (Step 1160).

When as the result of the reception of device information, the relevant processing device can determine that the relevant processing device itself is suitable for host processing device, it carries out the following processing: it notifies each slave processing device that it will operate as a host processing device and then operates as a host processing device (Step 1170, Step 1190).

When as the result of the reception of device information, the relevant processing device determines that it is not suitable for host processing device, it carries out the following processing: it waist for any other slave processing device to notify that the other processing device will operate as a host processing device and performs the subsequent operation with the notifying slave processing device taken as a host processing device (Step 1180).

The above procedure makes it possible to cope with cases where the host processing device 200 cannot communicate due to abrupt power-off or the like. A feature of this sequence is that a slave processing device utilizes beacon information and grasps that the host processing device 200 has become incapable of communication.

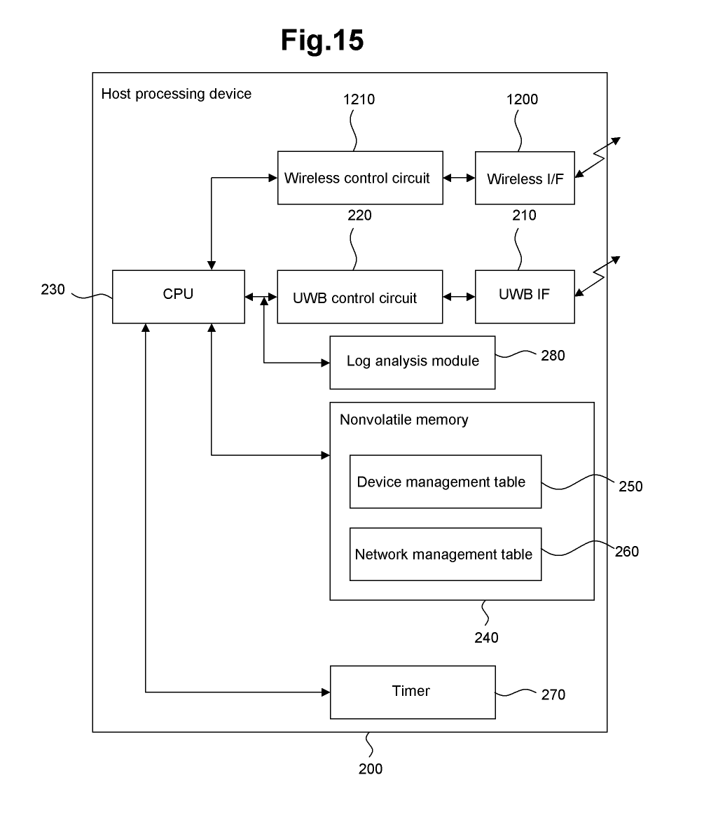

FIG. 15 illustrates as an example a host processing device obtained by adding a wireless interface 1200 and a wireless control circuit 1210 to the host processing device 200 illustrated in FIG. 2. The wireless interface 1200 is an interface for communicating with an external network and examples of the wireless interface include wireless LAN, cellular phone, and the like. A wired interface may be adopted in place of the wireless interface.

Incorporation of the wireless interface 1200 in the host processing device 200 makes it possible to acquire up-to-date information pertaining to the security of each slave processing device, that is, updator information, from an external network. The other respects of the configuration are the same as those in FIG. 2 and the detailed description thereof will be omitted.

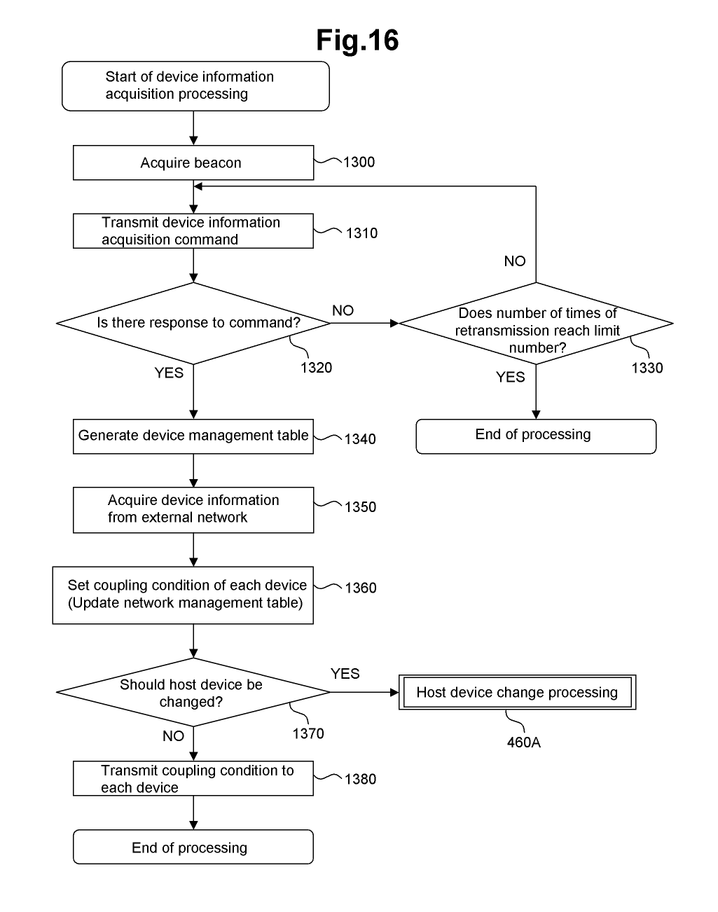

FIG. 16 illustrates an example of a control sequence in which a host processing device 200 equipped with a wireless interface 1200 utilizes information pertaining to security and manages a processing device newly added to the network. The processing in FIG. 16 corresponds to the device information acquisition processing illustrated in FIG. 10.

When after beacon information is acquired, there is a MAC address not registered in the device management table 250, the host processing device 200 carries out the following processing: it transmits a device information acquisition command to the processing device indicated by that MAC address and waits for a response to the command (Step 1300, Step 1310, Step 1320).

When there is no response to the device information acquisition command, the command is transmitted again. When the number of times of retransmission reaches a certain limit number, the device information acquisition processing is terminated (Step 1330). Even when beacon information transmitted by the processing device indicated by the MAC address cannot be confirmed, the device information acquisition processing may be terminated.

When there is a response to the device information acquisition command, a device management table 250 is generated utilizing information required to generate the device management table 250, contained in the response (Step 1340).

Subsequently, to acquire device information pertaining to the relevant processing device, the wireless interface 1200 is utilized to access an external network and information pertaining to the relevant processing device is acquired (Step 1350). Utilizing the acquired device information, the coupling condition of each slave processing device to the relevant processing device is set and the network management table is updated (Step 1360).

When after the device management table 250 and the network management table 260 are generated and updated, the relevant processing device is more suitable for host processing device in terms of performance and functionality, host device change processing is carried out (Step 1370, Step 460).

When the relevant processing device is not suitable for host processing device, the contents of the network management table 260 are transmitted to each slave processing device (Step 1380).

The above processing makes it possible to acquire up-to-date information pertaining to each slave processing device. If a new problem is found after shipping, therefore, device management can be carried out in accordance with the problem.

Up to this point, concrete description has been given to the invention made by the present inventors based on embodiments. However, the invention is not limited to these embodiments and can be variously modified without departing from its subject matter.

Some examples will be taken. The short-distance wireless interface is not limited to UWB or Bluetooth (registered trademark) and can be modified as appropriate. It only has to be a communication protocol that makes it possible to change a host device. The data processing device need not be a single-chip device and may be a multi-chip or a modular device or may be a board device formed over a wiring board. The memory circuit need not be EEPROM and only has to be an electrically rewritable appropriate memory, such as flash memory. The device management table and the network management table may be integrally composed and the contents of their entry data may be changed as appropriate. This is the same with the coupled device table. A short-distance radio communication network may include a data processing device operated only as a network slave, needless to add. In the data processing device that can be switched between a network slave function and a network host function, its functions need not be implemented by an operating program of a data processor, such as CPU. Part or all of the functions implemented by software can also be implemented by a hardware logic.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A data processing device coupled as a host device or a slave device to a radio communication network, comprising:
a radio communication circuit transmitting beacon information for making any other data processing device recognize the data processing device as the relevant device and receiving beacon information transmitted from any other data processing device; and
a control circuit carrying out control so as to cause the data processing device as the relevant device to participate as a host device or a slave device in the radio communication network according to whether or not beacon information transmitted from the other data processing device has been received.

2. The data processing device according to claim 1,
wherein the control circuit carries out control so as to cause the data processing device as the relevant device to participate as a host device or a slave device in the radio communication network according to whether or not beacon information transmitted from the other data processing device has been received and whether or not a host request command transmitted from the other data processing device has been received.

3. The data processing device according to claim 1,
wherein the control circuit carries out control so as to:
cause the data processing device as the relevant device to participate as a host device in the radio communication network when the radio communication circuit does not receive beacon information transmitted from the other data processing device;
cause the data processing device as the relevant device to participate as a host device in the radio communication network when the radio communication circuit receives the beacon information transmitted from the other data processing device and receives a host request command from the other data processing device; and
cause the data processing device as the relevant device to participate as a slave device in the radio communication network when the radio communication circuit receives the beacon information transmitted from the other data processing device and does not receive a host request command from the other data processing device.

4. The data processing device according to claim 3,
wherein when the host request command is received and the data processing device as the relevant device is caused to participate as a host device in the radio communication network, the control circuit updates a management table for the present host device sent back by transmitting a response to the host request command and generates its own management table for the host device in the memory circuit.

5. The data processing device according to claim 4,
wherein the management table for the host device comprises, for each address assigned to data processing devices, the attribute information of a data processing device and the address information of any other data processing device that can be coupled.

6. The data processing device according to claim 4,
wherein when the host request command is not received and the data processing device as the relevant device is caused to participate as a slave device in the radio communication network, the control circuit generates its own management table for the slave device in the memory circuit based on a coupling condition supplied from the host device.

7. The data processing device according to claim 6,
wherein the management table for the slave device comprises the address information of any other data processing device with which the relevant device is permitted to be coupled.

8. The data processing device according to claim 4,
wherein when the relevant device has been caused to participate as a host device in a network and the host request command is transmitted, the control circuit outputs a management table for the host device in response to a response from the destination of transmission and further updates the management table for the present host device in the memory circuit to its own management table for the slave device and causes the relevant device to participate as a slave device in the network.

9. The data processing device according to claim 8,
wherein when the relevant device has been caused to participate as a host device in a network and operation to interrupt operating power supply is performed, the control circuit transmits a host request command to a slave device, if any, that can substitute for a host function and transmits a management table for the host to a slave device that responds thereto.

10. The data processing device according to claim 1,
wherein when the relevant device has been caused to participate as a slave device in a network and beacon information cannot be received from the host device, the control circuit issues a host detection command to the data processing devices at all the addresses, acquires the attribute information of the data processing devices at all the addresses when the presence of the host device cannot be recognized by any response thereto, and declares that the relevant device will become the host device to the data processing devices at all the addresses when it is determined to be necessary based on the acquired attribute information.

11. A data processing method comprising:
first processing in which beacon information for making any other data processing device recognize the data processing device as the relevant device coupled as a host device or a slave device to a radio communication network is transmitted and beacon information transmitted from any other data processing device is received; and
second processing in which control is carried out so as to cause the data processing device as the relevant device to participate as a host device or a slave device in the radio communication network according to whether or not beacon information transmitted from the other data processing device has been received.

12. The data processing method according to claim 11,
wherein the second processing performs control is carried out so as to cause the data processing device as the relevant device to participate as a host device or a slave device in the radio communication network according to whether or not beacon information transmitted from the other data processing device has been received and whether or not a host request command transmitted from the other data processing device has been received.

13. The data processing method according to claim 11,
wherein the second processing performs control so as to:
cause the data processing device as the relevant device to participate as a host device in the radio communication network when the radio communication circuit does not receive beacon information transmitted from the other data processing device;
cause the data processing device as the relevant device to participate as a host device in the radio communication network when the radio communication circuit receives the beacon information transmitted from the other data processing device and receives a host request command from the other data processing device; and
cause the data processing device as the relevant device to participate as a slave device in the radio communication network when the radio communication circuit receives the beacon information transmitted from the other data processing device and does not receive a host request command from the other data processing device.

14. The data processing method according to claim 11,
wherein the processing in which when the host request command is received in the second processing, the data processing device as the relevant device is caused to participate as a host device in the radio communication network comprises processing in which a management table for the present host device sent back by transmitting a response to the host request command is updated to generate the relevant device's own management table for the host device in the memory circuit.

15. The data processing method according to claim 14,
wherein the management table for the host device comprises, for each address assigned to data processing devices, the attribute information of a device and the address information of any other data processing device that can be coupled.

16. The data processing method according to claim 11,
wherein the processing in which when the host request command is not received in the second processing, the data processing device as the relevant device is caused to participate as a slave device in the radio communication network comprises processing in which based on a coupling condition supplied from the host device, the relevant device's own management table for the slave device is generated in the memory circuit.

17. The data processing method according to claim 16,
wherein the management table for the slave device comprises the address information of any other data processing device with which the relevant device is permitted to be coupled.
